(19) United States
(12) Patent Application Publication
(10) Pub. No.: US 2007/0122604 A1
(43) Pub. Date: May 31, 2007

(54) Gypsum board and process of manufacture

(76) Inventors: Lance Wang, Parker, CO (US); James Patrick Hamilton, Parker, CO (US); Robert David Hamilton, Parker, CO (US); Philippe Marie Scheerlinck, Lakewood, CO (US); Albert G. Dietz III, Littleton, CO (US)

Correspondence Address: JOHNS MANVILLE, 10100 WEST UTE AVENUE, LITTLETON, CO, 80127, US

(21) Appl. No.: 11/287,788

(22) Filed: Nov. 28, 2005

(51) Int. Cl. B32B 13/08; B32B 29/02; B32B 13/02; B32B 13/14

(52) U.S. Cl. 428/294.7; 442/412; 427/372.2

(57) ABSTRACT

A gypsum board includes a set gypsum core and front and rear paper facers adhered thereto. At least the front paper facer has substantially isotropic tensile strength, thereby providing the gypsum board with enhanced nail pull resistance. A process for manufacturing such gypsum board is further provided.

### BACKGROUND OF THE INVENTION

1. Field of the Invention

The present invention relates to a gypsum board used in building construction and to a process for its manufacture; and more particularly, to a gypsum board or similar product in panel form having improved nail pull resistance, and processes for the manufacture thereof.

2. Description of the Prior Art

Wallboard formed of a gypsum core sandwiched between facing layers is used in the construction of virtually every modern building. In its various forms, the material is employed as a surface for walls and ceilings and the like, both interior and exterior. Wallboard is ordinarily affixed to wood or metal structural members of the building (e.g. studs or joists) by nails or, more commonly, by screws. It is relatively easy and inexpensive to install, finish, and maintain, and in suitable forms, is relatively fire resistant. Although kraft paper-faced wallboard is most commonly used for finishing interior walls and ceilings, other forms with different kinds of facings have superior properties that are essential for other uses.

Gypsum wallboard and gypsum panels are traditionally manufactured by a continuous process. A gypsum slurry is first generated in a mechanical mixer by mixing at least one of anhydrous calcium sulfate (CaSO₄) and calcium sulfate hemihydrate (CaSO₄.½H₂O, also known as calcined gypsum), water, and other substances, which may include set accelerants, waterproofing agents, reinforcing mineral, glass fibers, and the like. The gypsum slurry is normally deposited on a continuously advancing, lower facing sheet, such as kraft paper. The direction of advance of the facer defines a direction in the final product conventionally called the machine direction (MD), while the perpendicular direction across the width of the facer is the across machine direction (AMD). Various additives, e.g. cellulose and glass fibers, are often added to the slurry to strengthen the gypsum core once it is dry or set. Starch is frequently added to the slurry in order to improve the adhesion between the gypsum core and the facing. A continuously advancing upper facing sheet is laid over the gypsum. The edges of the upper and lower facing sheets are then pasted to each other, e.g. with a suitable adhesive. The facing sheets and gypsum slurry are passed between parallel upper and lower forming plates or rolls in order to generate a composite formed of an integrated and continuous flat core of unset gypsum sandwiched between the sheets. The composite is conveyed over a series of continuous moving belts and rollers for a period of several minutes, during which time the core begins to hydrate back to gypsum (CaSO₄.2H₂O). The process is conventionally termed “setting,” since the rehydrated gypsum is relatively hard. During each transfer between belts and/or rolls, the composite is stressed in a way that can cause the facing to delaminate from the gypsum core if its adhesion is not sufficient. Once the gypsum core has set sufficiently, the continuous composite is cut into shorter lengths or even individual boards or panels of prescribed length.

After the cutting step, the cut composites are fed into drying ovens or kilns so as to evaporate excess water. Inside the drying ovens, the composites are blown with hot drying air. After the dried gypsum composites are removed from the ovens, their ends are trimmed off and they are cut to desired sizes to form finished gypsum boards. The boards are commonly sold to the building industry in the form of sheets nominally 4 feet wide and 8 to 12 feet or more long and in thicknesses from nominally about ¼ to 1 inch. The width and length dimensions define the two faces of the board.

Prior to being deposited on the lower facer, the gypsum slurry is often foamed by intense mechanical agitation, sometimes in conjunction with a foaming agent, prior to being deposited on the lower facer. The foaming is done to reduce the core density, and thus the weight of the finished board. The reduced weight in turn reduces the amount of raw material required and the costs of storage and shipment, while facilitating handling and installation at a construction site.

An ideal wallboard should have mechanical properties that permit it to withstand the forces encountered during manufacture, transport, installation, and use. Two of the most crucial properties are flexural strength and nail pull resistance. Recognized techniques for measuring these and other important mechanical properties are contained in ASTM Standard Test Method C473-03, which is promulgated by the American Society for Testing and Materials.

Flexural strength of wallboard ordinarily is characterized by correlated measurement of: (i) the centrally applied load that causes the board to break in flexure; and (ii) the amount of deflection at the failure point. The mechanics of flexure entail a combination of tensile and compressive stresses, so that flexural properties are indirectly related to the tensile and compressive properties that would be measured with uniaxially applied forces.

The aforementioned ASTM C473-03 standard provides techniques for flexural strength measurement of gypsum wallboard. Method B, Section 11 of ASTM C473-03 specifies a test depicted generally at 60 by FIG. 1. A rectangular wallboard sample 62 is supported near two of its opposing sides and along its full length by parallel bars 64 attached to rigid support plate 66. Downward force is applied in the direction of arrow 70 to a loading bar 68 that extends the full length of sample 62 at its midline. The face contacting support bars 64 is, of course, placed in tension, while the opposite face undergoes compression. Bars 64 and 68 have radiused ends to engage the opposing surfaces of the wallboard. The testing is ordinarily carried out using a conventional mechanical testing machine that records a stress-strain curve relating the force applied to loading bar 68 and the axial displacement associated therewith.

Another critical property is nail pull resistance. Wallboard is most commonly installed using fasteners such as nails or screws driven through the board face to engage appropriate skeletal building structural members. Ordinarily, the fastener is driven so that its head is situated just below the planar surface of the wallboard, creating a dimple in the wallboard face. When the board is manually nailed, the dimple approximately replicates the size of the hammer or like tool used to drive the nail, whereas in screw installations, the dimple is about the size of the screw head. In either case, the dimple is then filled with a suitable spackling compound that hides the fastener and levels the surface, thereby permitting the wall or ceiling to be finished in an aesthetically pleasing manner by painting, wallpapering, or other known finishing technique.

For a satisfactory installation, the wallboard must have adequate strength to permit its weight, as well as any additional load borne by it, to be carried by the fasteners used to adhere the board to the internal building structure. If that strength is inadequate, the fastener can pull through the board. That is to say, a portion of the board in the vicinity of the fastener fails mechanically, allowing the head of the fastener to pull completely through the board thickness. Thus, that fastener no longer provides any attachment of the board to the building structure, and it no longer carries any part of the weight of the board or associated loads.

ASTM C473-03 also contains techniques for measuring nail pull resistance. The method of ASTM C473-03, Method B, Section 13, is depicted generally at 40 by FIG. 2. A specimen of gypsum wallboard 42 is placed atop a rigid support fixture 44 having an aperture 45. A slightly oversized pilot hole 46 is drilled through the thickness of wallboard 42 to accommodate nail 47. Force is then applied to nail 47 along its axis and in the direction of arrow 48. ASTM C473-03 specifies a 3 inch diameter circular aperture 45, with nail 47 located at the aperture's center. The nail 47 has a shank diameter of 0.099 inches and a head with diameter 0.25 inches. The testing is ordinarily carried out using a conventional mechanical testing machine that records a stress-strain curve relating the force applied to nail 47 and the axial displacement associated therewith.

The art has long sought gypsum board products having improved mechanical properties, including inter alia the aforementioned flexural strength and nail pull resistance. It is known that the commonly used forms of wallboard derive significant portions of their flexural strength from both their facers and the gypsum core. Approaches have thus been proposed that address both constituents. For example, US Patent Publication US 2004/0092624 A1 to Tagge et al. discloses the use of a cellulose ether additive to gypsum slurry that is said to provide a reinforced gypsum wallboard core having improved nail pull resistance and flexural strength than unreinforced wallboard of the same density. The '624 reference also discloses reduction of the density of the gypsum core by the addition of porosity or a low-density filler such as perlite. However, either of these approaches is said to result in a dramatic loss of strength and nail pull resistance.

These detriments can be compensated partially by the use of core additives such as cellulosic particles and fibers. Glass fibers are frequently used, but are said not to adhere well to the gypsum matrix and to be easily dislodged during board handling, installation, or demolition to cause irritation of the skin or respiratory tract, e.g. for construction workers or building occupants. Alternatively, polymers and starches have been incorporated in the core.

Based on conventional experience with glass fiber reinforced organic polymeric composite materials, use of improved glass fiber sizing treatment has been proposed. In the polymeric composites, it is known that suitable sizing enhances strength by improving the adhesion between the fibers and the matrix material. Accordingly, it has been assumed that improved fiber-gypsum bonding would also improve properties of reinforced gypsum board. US Patent Publication US 2003/0219580 A1 to Tagge et al. discloses surface modification of reinforcing fiber that is also said to enhance the cohesion between the fiber and gypsum in a wallboard core. The '580 reference also discloses the use of multi-ply paper facer sheets having oriented fibers to increase wallboard flexural strength.

The use of non-woven glass fiber mats as facers to improve the strength of gypsum boards has also been suggested, e.g. by US Patent Publication 2002/0187298 A1 to Hauber et al.

While certain improvements have been achieved in the aforementioned mechanical properties, none of the approaches to date has proven entirely satisfactory. In many cases, improvement has been attained in some, but not all of the desired characteristics. Moreover, many of the improvements in certain strength properties have concomitantly resulted in disadvantages in weight, manufacturing economy, and greater difficulty in installation and use of the product. Improving nail pull resistance without increasing weight and cost has proven especially elusive.

### SUMMARY OF THE INVENTION

The present invention provides a gypsum board and a process for the manufacture thereof. The board comprises a core comprising set gypsum and front and rear paper facers respectively adhered to front and rear surfaces of the core. At least the front paper facer has a substantially isotropic tensile strength.

The gypsum board of the invention typically is used for a number of purposes in building construction, such as a surface material for walls and ceilings and as an underlayment for floors, roofs, and the like. The board finds application in both interior and exterior environments. The use of paper facers having substantially isotropic tensile strength affords the gypsum board with nail pull resistance that is improved over that exhibited by boards employing conventional, orthotropic kraft paper facers.

In another aspect, the invention provides a process for manufacturing gypsum board and other hydraulic set and cementitious board products for interior and/or exterior use, i.e. products appointed for installation on either interior or exterior surfaces of building structures. By exterior surface is meant any surface of a completed structure expected to be exposed to weather; by interior surface is meant a surface within the confines of an enclosed, completed structure and not intended to be exposed to weather.

In an embodiment there is provided a process comprising: (i) providing upper and lower paper facers, at least one of the facers having substantially isotropic tensile strength; (ii) preparing a primary aqueous slurry comprising at least one of anhydrous calcium sulfate, calcium sulfate hemi-hydrate, or cement; (iii) forming a gypsum layer by depositing the primary aqueous slurry on the lower paper facer; (iv) applying the upper paper facer onto the top of the gypsum layer to produce a board pre-form; (v) drying the pre-form to effect curing of the gypsum layer into the set gypsum core and form the board.

Other process aspects, including for example, those described in U.S. Pat. Nos. 4,647,496, 5,220,762, 6,524,679, all herein incorporated by reference, find utility in production of the present gypsum board.

### BRIEF DESCRIPTION OF THE DRAWINGS

The invention will be more fully understood and further advantages will become apparent when reference is had to the following detailed description of the preferred embodiments of the invention and the accompanying drawing, wherein like reference numerals denote similar elements throughout the several views, and in which:

FIG. 1 is a schematic, cross-sectional view of an apparatus for testing the flexural strength of gypsum wallboard;

FIG. 2 is a schematic, cross-sectional view of an apparatus for testing the nail pull resistance of gypsum wallboard;

FIG. 3 is a broken cross-sectional view of a paper faced gypsum board of the invention;

FIGS. 4A-4E are metallographic, cross-sectional views of a gypsum board at various stages of nail pull resistance testing;

FIG. 5 is a plot depicting the stress-strain behavior of an idealized gypsum board undergoing nail pull resistance testing;

FIG. 6 is a schematic diagram of a process for manufacturing a gypsum board in accordance with the invention; and

FIG. 7 is a cross-sectional view of another paper faced gypsum board of the invention.

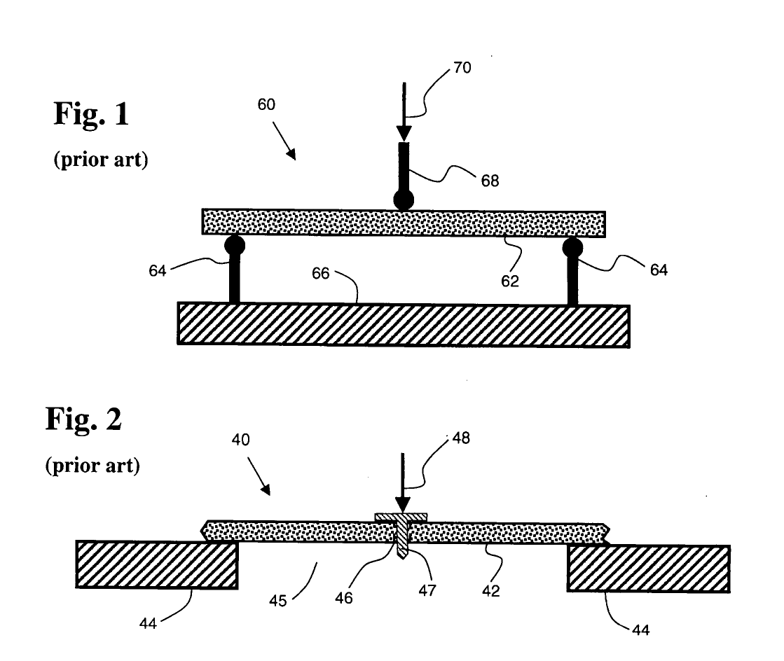

### DETAILED DESCRIPTION OF THE INVENTION

The present invention provides gypsum board and other hydraulic set and cementitious boards having front and back large surfaces. By hydraulic set is meant a material capable of hardening to form a cementitious compound in the presence of water. Typical hydraulic set materials include gypsum, Portland cement, pozzolanic materials, and the like. The board is faced on both surfaces with paper facers, at least one of the facers having substantially isotropic tensile strength.

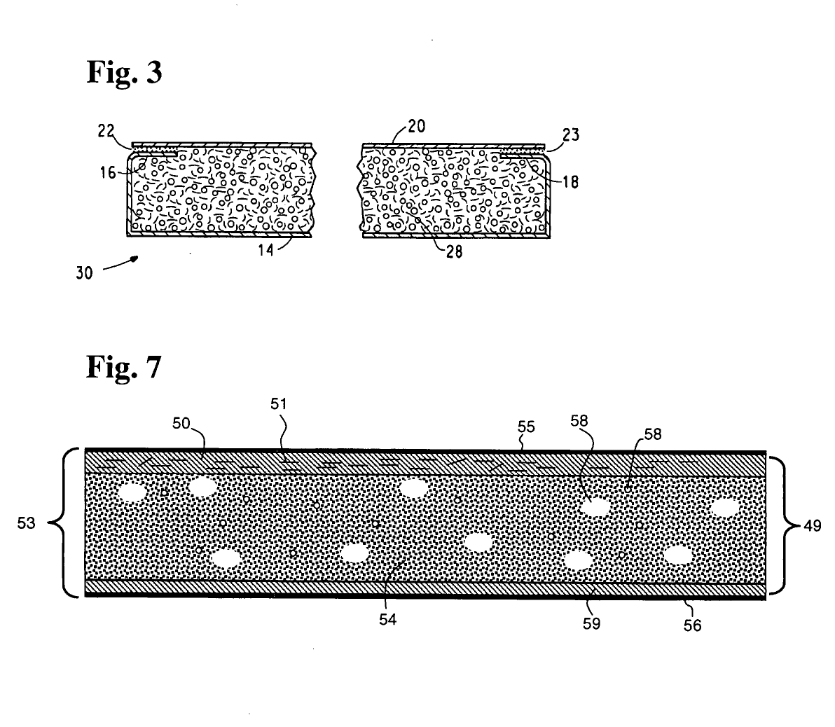

Referring now to FIG. 3, there is shown generally at 30 a sectional view across the width (the across machine direction) of one embodiment of a gypsum board in accordance with the invention. The board comprises a layer of set gypsum 28, which is sandwiched between front and rear paper facers 14, 20, and bonded thereto. Two right-angled folds are formed in each lateral edge of front facer 14, a first upward fold and a second inward fold. A small distance having approximately the preselected thickness of the board separates the two folds. The second fold defines longitudinally extending strips 16 and 18 that are substantially parallel to the main part of the facer. A rear paper facer 20 covers the other side of the set gypsum core 28. The respective lateral edges of second paper facer 20 are affixed to strips 16 and 18, preferably with adhesive 22, 23. First paper facer 14 has a substantially isotropic tensile strength. Ordinarily board 30 is installed with the side bearing front facer 14 toward a finished space. The board is advantageously ready for painting, but other finishing forms such as plaster, wallpaper or other known wall coverings may also be applied with a minimum of surface preparation.

Studies of the evolution of the microstructure of conventional gypsum board during nail pull and tensile testing have been conducted to elucidate the important failure mechanisms.

### Tensile Testing of Conventional Gypsum Wallboard

Conventional gypsum wallboards similar to those generally depicted by FIG. 3, but having conventional kraft paper facers, are prepared using conventional industrial production processes. The boards are nominally ½ inch thick and employ kraft paper facers having a basis weight of about 0.747 ounces per square foot (0.228 kg/m²). Two types of wallboard are tested, one (Type A) being a standard, unreinforced board, the other (Type B) having glass fiber reinforcement in the gypsum core.

Mechanical testing is conducted to determine the strengths of the overall board and of the kraft paper facers and the gypsum core by themselves. The tensile properties are tested in the board plane and in both the MD and the AMD. Compression behavior is tested in the direction of the board thickness.

Samples of both the front and rear surface kraft papers used are separately tested with specimens having a conventional dog-bone shape with a 0.25 inch wide by 1.5 inch long reduced section. Specimens of each type are cut from the respective paper supplies using a metal die and mounted in a conventional mechanical testing machine. Samples of intact, composite wallboards (Types A and B) are also tested in the form of dog-bone shape specimens with a 0.5 inch wide by 1.5 inch long reduced gage section. Samples for testing the core itself are prepared in the form of rectangular specimens 1 inch wide by 6 inches long taken from the finished board. At the mid-length of each specimen, a band of the paper facers 0.5 inch wide and extending across the full width is removed from each side of the wallboard using an end mill. All of the testing is carried out in a conventional mechanical testing machine using a crosshead speed of 0.14 inch/min. Samples of the paper, the gypsum core, and the composite wallboards are all tested in both the machine direction (MD) and the across machine direction (AMD). Tensile strength data are delineated in Table I below.

TABLE 1
Tensile Properties of Conventional
Wallboard and Wallboard Components
Tensile Properties of Paper*

| | | Tensile Load | |
|---|---|---|---|
| Paper Type | Orientation | (lbs) | Strength (psi) |
| Front | MD | 19.20 | 6352 |
| Front | AMD | 5.29 | 1659 |
| Back | MD | 18.22 | 6785 |
| Back | AMD | 6.02 | 2085 |

*0.25 inch wide gage section

| | | | |
|---|---|---|---|
| | | Tensile Load | |
| Sample Type | Orientation | (lbs) | Strength (psi) |

Core Tensile Properties*

| | | | |
|---|---|---|---|
| A (no fibers) | MD | 22.1 | 48 |
| A (no fibers) | AMD | 51.7 | 111 |
| B (fibers) | MD | 100.7 | 218 |
| B (fibers) | AMD | 50.7 | 108 |

*1.0 inch wide gage section

Composite Wallboard Properties*

| | | | |
|---|---|---|---|
| A (no fibers) | MD | 81.2 | 335 |
| A (no fibers) | AMD | 26.6 | 109 |
| B (fibers) | MD | 100.8 | 411 |
| B (fibers) | AMD | 27.6 | 112 |

*0.50 inch wide gage section

Surprisingly, the kraft paper used for both front and rear facers of the board is highly orthotropic, showing a strength that is at least about 3 times higher in the MD than in the AMD. Without being bound by any theory, it is believed that the orthotropy of the paper reflects preferential orientation in the MD of the pulp fibers in the paper. Such an orientation is believed, in turn, to result from the high speed delivery of fibers in the continuous wet laying process generally employed in paper making, e.g., that process carried out using a Fourdrinier machine.

On the other hand, the conventional core itself is somewhat orthotropic, but to a lesser degree. The unreinforced core is about twice as strong in the AMD as the MD. Adding glass fiber reinforcement provides the core itself about a 5-fold increase in the MD strength, but unexpectedly does not affect the AMD strength appreciably. Glass fibers are typically incorporated as part of the preparation of gypsum slurry in a mechanical mixer. The same dynamics that tend to orient the pulp fibers in kraft paper facers are also believed to result in a preferred MD orientation of glass fibers in the delivered slurry. Nonetheless, the intact board (whether or not the core is fiber reinforced) has an overall anisotropy of strength, being 3-4 times stronger in the MD than the AMD. In addition, the reinforcement has a small beneficial impact on MD strength but only a minimal impact on AMD strength.

Compression testing of conventional gypsum wallboards is carried out with samples taken from the same Type A and B materials used for the foregoing tensile testing. One inch square coupons are placed between steel platens mounted in a mechanical testing machine driven at a constant crosshead speed of 0.14 inch/min.

The results of the compression tests reveal that the two types of wallboard exhibit different behaviors. The Type A wallboard (no glass reinforcing fibers) exhibits a peak load followed by a sharp drop in load, similar to a drop in the beam yield point behavior exhibited by structural steels that are tested in tension. With further application of load, the load displacement curve tends to be horizontal or to increase only slightly. The peak loads exhibited by these specimens range from 377 to 422 pounds.

On the other hand, Type B specimens (glass fiber reinforced) show only a small or virtually no drop in load after the initial deviation from linearity occurs. The load then continues to rise slightly (but more than for the non-fiber containing samples) as the test continues. These results show that the presence of the glass fibers influences the behavior of the wallboard during compression testing. The compression data are set forth in Table II below:

TABLE II
Compression Testing of Conventional Gypsum Wallboards

| Sample Type | Max. Load (lb.) | Average Max. Load (lb.) |
|---|---|---|
| A (no fibers) | 372-422 | 395 |
| B (fibers, first break) | 290-401 | 324 |
| B (fibers, secondbreak) | 320-471 | 375 |

### Flexural Testing of Conventional Gypsum Wallboards

Flexural testing of conventional gypsum wallboards is carried out using procedures generally outlined in ASTM Standard Test Method C473-03, Method B, Section 11. Tests are conducted using samples of the same Type A and Type B wallboards used in the foregoing tests. Samples 12 inches by 4 inches are cut and supported centered and with their long dimension spanning rails spaced 10 inches apart. Load is applied along a line applied at the mid-length of the sample and midway between the outer support rails. A crosshead speed of 1 inch/min is used. Separate tests are run with composite wallboard samples having either the MD or AMD oriented along the long sample dimension, and either with the front or rear facer loaded in tension. Tests are also run in all the orientations with the paper facers removed from both sides. Results of these tests are summarized in Table III.

TABLE III
Flexural Testing of Conventional Gypsum Wallboards

| | | Side Loaded | | |
|---|---|---|---|---|
| Sample Type | Direction | in Tension | Load (lbs) | Deflection (in.) |
| A | MD | Back | 69.4 | 0.24 |
| A | MD | Front | 71.7 | 0.275 |
| A | MD | No Paper | 16.5 | 0.032 |
| A | AMD | Back | 30.4 | 0.665 |
| A | AMD | Front | 32.1 | 0.48 |
| A | AMD | No Paper | 13.1 | 0.03 |
| B | MD | Back | 65.3 | 0.24 |
| B | MD | Front | 67.3 | 0.3 |
| B | MD | No Paper | 5.5 | 0.016 |
| B | AMD | Back | 29.8 | 0.73 |
| B | AMD | Front | 26.5 | 0.48 |
| B | AMD | No Paper | 12.3 | 0.034 |

These results show that the flexural strength of wallboard is provided predominantly by the facers, which are much stronger in tension than the gypsum core itself. There is only a slight difference between the flexural strength of the wallboard panels with and without fibers. Likewise, comparison of measurements made with the front and back paper side of the specimen placed in tension show only slightly different flexural strength. However, there is a strong specimen orientation effect: the flexural strengths in the MD are about 2.3 times higher than those in the AMD and there is marked directional difference in deflection of the specimens at the point of failure. For example, the specimens with the front surface loaded in tension have deflections in the AMD that are more than twice those in the MD; and for the specimens with the back surface side loaded in tension, the deflections in the AMD are nearly three times higher. Similar to the tensile strength of the core in the MD, which is enhanced about three-fold by the presence of glass fibers, the flexural strength of the core in the MD is enhanced three-fold. However, the fibers do not have a great effect on either flexural or tensile strengths in the AMD.

Furthermore, the strengths of conventional wallboards in flexure generally mirror the behavior in uniaxial tension. Both tests show a significant influence of specimen orientation on strength. The reinforcing fibers strengthen the core in the MD, whether measured in flexure or uniaxial tension, but the strength of the paper nevertheless predominates the overall strengths of the composite panels.

Nail pull resistance testing of conventional gypsum wallboards is carried out using procedures generally outlined in ASTM Standard Test Method C473-03, Method B, Section 13. Tests are conducted on samples of the same Type A and Type B wallboards used in the foregoing tensile, compression, and flexural tests. Set forth in Table IV are the range of maximum loads encountered and the average of these values.

TABLE IV
Nail Pull Resistance Testing of Conventional Gypsum Wallboards

| Sample | Max. Load (lb.) | Average Max. Load (lb.) |
|---|---|---|
| A (no fibers) | 73-88 | 80 |
| B (fibers) | 79-87 | 82 |

It is surprising and unexpected that the addition of reinforcing fibers does not appreciably increase the nail pull resistance of paper-faced gypsum wallboard.

Without being bound by any theory, it is believed that the orthotropy of the paper facers, in combination with the failure of the reinforcing fibers to enhance the AMD tensile strength, is responsible for the lack of enhancement in nail pull resistance. Further substantiation of this hypothesis is provided by microscopic studies of nail pull failure in conventional gypsum boards.

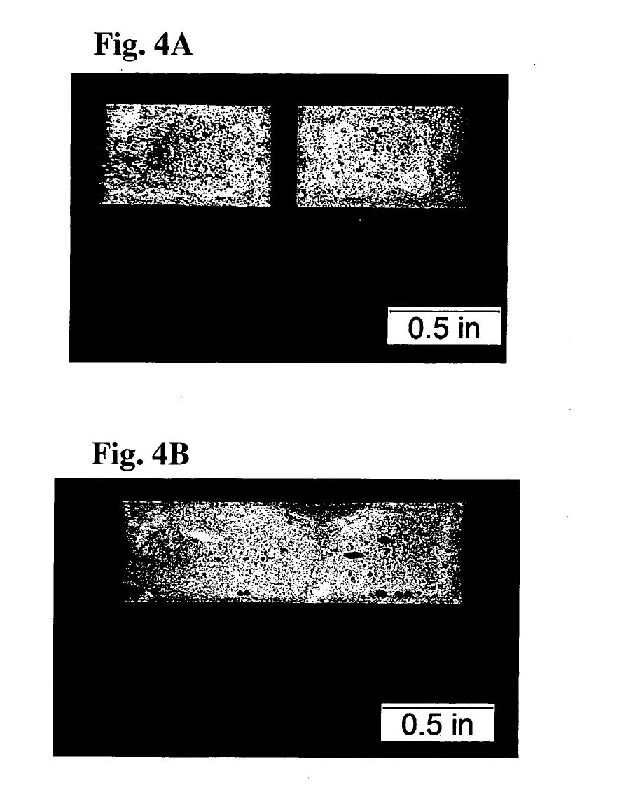

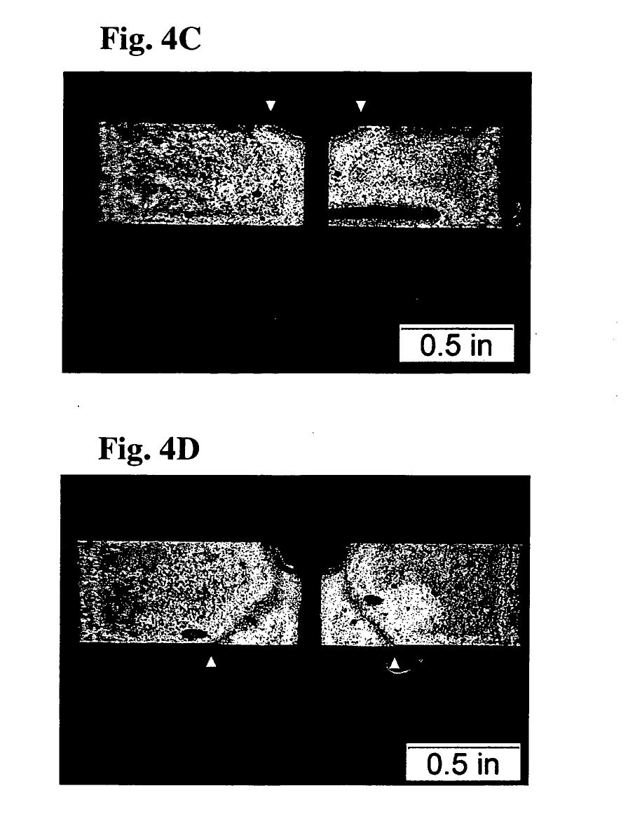

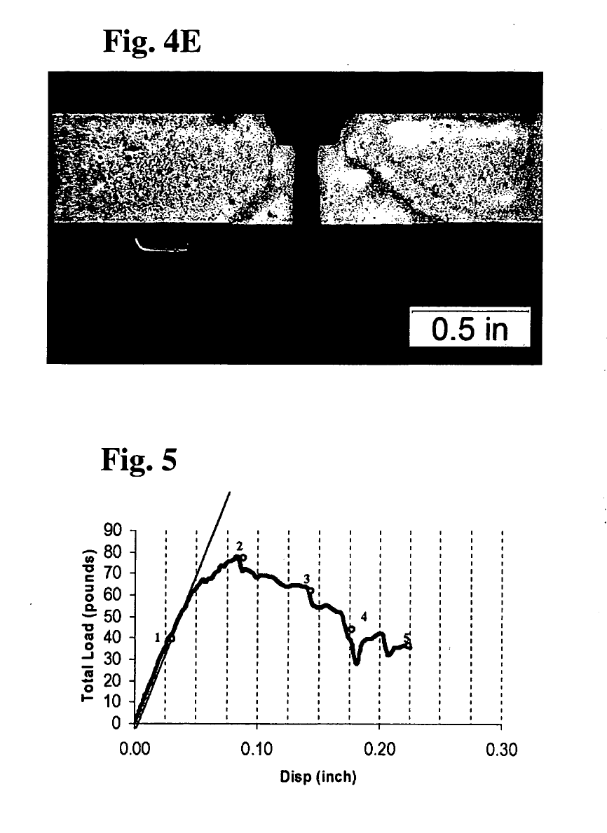

FIGS. 4A-E show a series of metallographic cross-sections of a conventional, unreinforced, nominally 0.5 inch thick gypsum wallboard. The various metallographs are taken on samples subjected to partial nail pull testing experiments that are interrupted at successive stages. The test points relate to the evolution of the stress-strain curve of FIG. 5, which represents behavior of an idealized gypsum board as determined obtained by numerical simulation. Specimens are mounted in a cast epoxy and prepared using conventional metallographic sectioning.

More specifically, FIG. 4A shows a cross section traversing the pilot hole in a nail pull resistance test specimen prior to testing. The porosity typical of conventional gypsum board is readily apparent. FIGS. 4B-E illustrate the progression of damage near the nail position from Points 1 through 4 in FIG. 5. At loads just beyond Point 1, the top paper is depressed slightly and the gypsum just below the top paper had been crushed, resulting in separation below the paper (FIG. 4B). No microcracks or larger cracks are observed in the gypsum core below the region where the gypsum is crushed. FIG. 4C, taken just beyond Point 2 (maximum load) of FIG. 5, shows the top paper depressed further into the gypsum core and the gypsum below it somewhat more compressed. In addition, there are seen tears in the top paper beginning at the locations indicated by the arrows. Examination of the section does not reveal other cracks in the gypsum core. The large cigar-shaped region extending into the core from the right side of the pilot hole near the bottom of the specimen is an artifact, specifically a large void in the gypsum core that is filled with the metallographic mounting material.

FIG. 4D illustrates the damage in the nail pull resistance specimen after loading to just past Point 3 in FIG. 5. In this section, the plunger penetrates to a depth about 25 percent through the nominal 0.5 inch wallboard thickness. The top paper is completely torn and pushed into the depression formed by the plunger, and the gypsum below the depression is strongly compressed. In addition, the micrograph reveals that cracks form and propagate from the periphery of the plunger and extend through the gypsum core at angles of about 45 degrees. These cracks indicate that a truncated cone-shaped plug is being pushed out of the core. Where these cracks intersect the bottom paper, some separation of the paper from the core is evident in the region indicated by the arrows. At still higher displacement (just beyond Point 4 of FIG. 5), FIG. 4E shows even more extensive damage of the type also shown in FIG. 4D. This section reflects a plunger penetration into the core to a depth of about 30 percent of the specimen thickness. Collectively, these metallographs indicate the complexity of the micromechanics of failure in nail pull testing. Both the core and both facers are clearly involved in failure, and both tensile and compressive failures are evident in different portions of the failure region.

As is apparent from the metallographs of FIGS. 4B-C, the first stage of failure in nail pull resistance is marked by compression of the gypsum core in the vicinity of the nail head, along with tensile failure of the paper facer at the periphery of the nail head. Conventional wallboard employs a kraft paper front facer with highly orthotropic mechanical properties. In particular, the kraft paper is stronger and stiffer in the MD. Accordingly, in the early stages much more of the AMD compressive stress must be sustained by the gypsum core. However, as the porous gypsum matrix is crushed, it softens, lowering the stress level but transferring the load predominantly into tension in the facer. Damage and strain softening occurs in the AMD first, which begins the failure process. As the nail displacement increases, the gypsum core continues to crush, and oblique shear cracks develop, as seen in FIGS. 4D-E. Eventually, the lower facer tears, leading to complete failure and removal of a cone-shaped plug. Although the gypsum core is highly porous, its micromechanical properties are analogous to those of various concrete-type materials, typically exhibiting relatively low strength and brittle failure in tension, and crushing and strain softening in compression.

The foregoing data and the related metallographs demonstrate that a complex interplay of the compressive and tensile properties of both the facers and the core affect the mechanical properties, especially nail pull testing behavior. In particular, the nail pull resistance of conventional gypsum board is limited primarily by AMD properties, which are generally inferior to the MD properties. Moreover, many of the ameliorative measures disclosed by the prior art benefit certain of the properties, especially in the MD, but surprisingly have little or no positive impact on other important mechanical properties of the composite structure, such as nail pull resistance.

By way of contrast, board produced in accordance with one aspect of the invention employs a front facer made of paper that has substantially isotropic tensile properties. That is to say, the paper has a tensile strength measured in the MD that is at most about three (3) times the tensile strength measured in the AMD. Preferably, the ratio is at most about 2:1 and more preferably is at most about 1.5:1. Even more preferred is paper wherein the ratio is at most about 1.2:1. The use of paper facers having more isotropic tensile strength improves nail pull resistance. It is believed that the improvement stems largely from the propensity of such paper to resist the facer tearing and crushing of the gypsum proximate the nail location. One form of paper having such properties is a multiply paper in which the fibers in at least one of the plies are preferentially oriented in a direction other than the MD, as viewed when the paper is disposed in the composite board. Such a ply has a tensile strength that is higher when measured in a direction other than the machine direction than when measured in the machine direction. The present invention further provides an embodiment wherein both the front and rear facers of the gypsum board employ papers having substantially isotropic tensile properties.

The properties of the present gypsum board, including both nail pull resistance and tensile strength, are further improved by using paper facers having higher strength. For example, a board employing a front paper facer having a tensile strength double that of conventional paper facer in both the MD and AMD can have a nail pull resistance that is enhanced by as much as 20% or more. Improvement of strength can be accomplished in various ways, including use of paper having increased thickness and basis weight, changes in processing that alter the orientation distribution of fibers to increase the isotropy of the distribution, and by use of suitable additives. On the other hand, nail pull resistance can also be improved by increasing the AMD tensile strength even without increasing MD strength. In some cases, the basis weight of the facer paper can even be decreased without reducing nail pull resistance, by using paper with a lower MD strength but a higher AMD strength than conventional kraft facer paper. Advantageously, the substantially isotropic characteristic of wallboard produced in accordance with the present invention affords significantly greater increases in nail pull resistance than would ordinarily be expected with increased paper weights. Also afforded is the achievement of excellent nail pull resistance with unexpectedly lower paper weights.

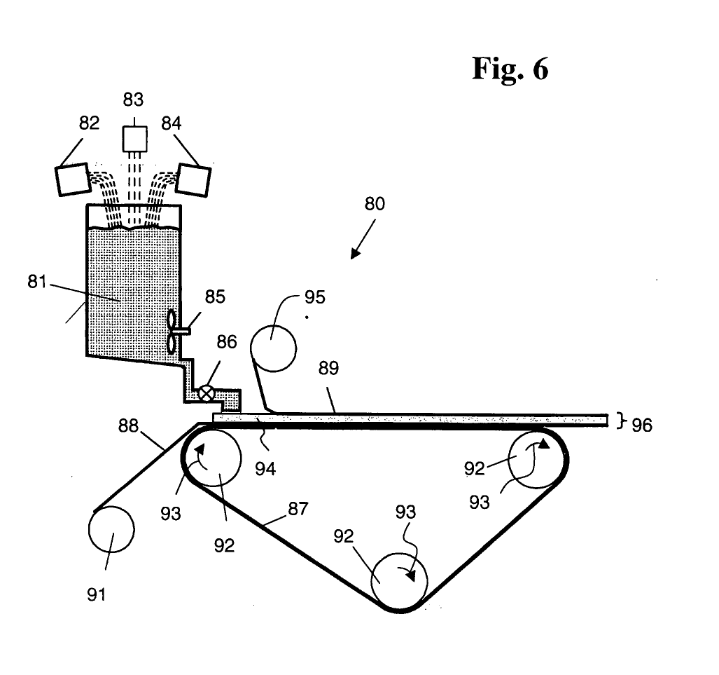

Turning now to FIG. 6, there is depicted generally at 80 an embodiment of a process for manufacturing gypsum wallboard in accordance with an aspect of the invention. Primary aqueous gypsum slurry is prepared in mixer 81. Water and the other required constituents of the slurry are added at a suitable rate. Either calcined or anhydrous gypsum are delivered from supply 82. Reinforcing fibers, which may be glass or polymeric, are optionally added as well. Agitator 85 stirs the mixture to form a gypsum slurry of desired consistency and density. Preferably, agitator 85 imparts sufficient shear to cause foaming of the slurry. Optionally, the foaming is produced or enhanced by introducing foaming agent 83. Other desired additives 84 may also be added.

Lower paper facer 88 is delivered from a supply roll 91 and continuously advanced in the MD by moving belt 87 that is supported by suitable motor-driven rollers 92 turning in the direction indicated by arrows 93. Slurry is conveyed from mixer 81 through suitable piping, troughs, nozzles, or the like. The delivery of slurry onto lower paper facer 88 is regulated by metering valve 86. Suitable rollers, doctor blades, or the like (not shown) are preferably used to disperse and level the slurry to a desired even layer 94. An upper paper facer 89 is delivered from supply roll 95 in a converging relationship onto the top surface of layer 94 to form a wet gypsum board pre-form 96. Suitable top, bottom, and side edge guides, nip rollers, or the like (not shown) are used to insure the thickness and width of pre-form 96 are in accord with the desired dimensions of the finished gypsum board. Pre-form 96 is then conveyed to suitable drying ovens (not shown) to cause evaporation of excess water and proper setting of the gypsum core, whereby the requisite mechanical properties are developed. Needed trimming operations and cutting of the pre-form are carried out to produce final gypsum boards having preselected dimensions.

The slurry optionally includes reinforcing fibers or other known additives used as process control agents or to impart desired functional properties to the board, including one or more of agents such as biocides, flame retardants, and water repellants. The product of the invention is ordinarily of a form known in the building trades as board, i.e. a product having a width and a length substantially greater than its thickness. Gypsum and other hydraulic set and cementitious board products are typically furnished commercially in nominal widths of at least 2 feet, and more commonly 4 feet. Lengths are generally at least 2 feet, but more commonly are 8-12 feet.

The nail pull resistance, flexural strength, and other mechanical properties of the present gypsum board may be further enhanced by using a gypsum core which comprises a central layer and a thin front surface layer between the central layer and the front paper facer. Both layers comprise set gypsum, but the front surface layer has a density that is higher than that of the central layer. Such a surface layer might be deposited from a source of a denser gypsum slurry that is either not foamed at all or is less highly foamed than the slurry used for the central layer. Such a surface layer may also comprise reinforcing fibers, such as glass fibers. Preferably, such fibers, if used, are substantially isotropically oriented. That is to say, the fibers are oriented in directions that are substantially random within the thin layer, rather than being predominantly aligned along the MD as in conventional reinforced board. The thin layer has a thickness that preferably ranges from about 0.1 to 2 mm. The gypsum board may also include a thin rear surface gypsum layer between the central layer and the rear paper facer, the rear surface gypsum layer also having a density that is higher than that of the central gypsum layer.

An embodiment of such a gypsum board is depicted by FIG. 7. Board 53 comprises a front paper facer 55 and a rear paper facer 56, and a set gypsum core 49. Core 49 includes a center layer 54 and front and rear surface layers 50, 59. Voids 58 of various sizes are included in foamed center layer 54. Front surface layer 50 comprises glass fibers 51 distributed with an orientation distribution that is substantially isotropic with respect to the MD and the AMD of board 53.

In still another embodiment, the board comprises a non-woven glass fiber mat disposed between the front paper facer and a center of the gypsum core. The non-woven mat lies substantially in a plane that is parallel to the surface of the board. Alternatively, the mat may be disposed on a front surface layer if one is used or located within the gypsum core but near the facer. The presence of such a mat affords considerable enhancement of the tensile strength of the board in the AMD.

The gypsum core in certain embodiments contains reinforcing fibers, at least a preponderance of which are selected from the group consisting of fibers of glass, mineral wool, slag wool, ceramic, carbon, metal, refractory materials, melt-blown micro-denier synthetic fibers, and mixtures thereof. Preferably, the fibers constitute up to about 1-5 wt. % of the core and are distributed with an orientation distribution that is substantially isotropic. By a substantially isotropic orientation distribution is meant the number of glass fiber per unit cross section area along MD is substantially equivalent to that of AMD which can be measured by laser scanning after score and snap of the board. If the reinforcing fibers are introduced as part of the slurry, the speed of production and the delivery configuration are preferably selected to promote this substantial isotropy.

In another alternative embodiment, reinforcing fibers are dispersed in a layer on the front paper facer of the board prior to deposition of gypsum slurry thereon. An adhesive, tacky agent, or the like, may be used to stabilize the position of the fibers during the slurry deposition. Preferably, the reinforcing fibers in the layer are distributed with a substantially isotropic orientation distribution. The placement of fiber directly onto the paper facers of the present board permits a high concentration at the surface, where reinforcement is most beneficial for flexural strength and nail pull resistance. Moreover, such a technique overcomes the difficulty of increasing fiber content in a slurry beyond about 0.63 wt. % (equivalent to about 10 pounds per thousand square feet of board area). Higher fiber content in slurry results in significant problems in maintaining rheological characteristics acceptable for reliably delivering slurry onto the facers in a continuous process.

The gypsum core of the present construction board may also include one or more conventionally used constituents, including water repellant agents, reinforcing fiber, starch, polymeric additives, biocide.

Optionally the paper facers of the present wallboard further contain fillers, pigments, or other inert or active ingredients. For example, the facer can contain effective amounts of fine particles of limestone, glass, clay, coloring pigments, biocide, fungicide, intumescent material, or mixtures thereof. Such additives may be added for known structural, functional, or aesthetic qualities imparted thereby. These qualities include coloration, modification of the structure or texture of the surface, resistance to mold or fungus formation, and fire resistance. Preferably, flame retardants sufficient to provide flame resistance, e.g. according to NFPA Method 701 of the National Fire Protection Association or ASTM Standard E84, Class 1, by the American Society for the Testing of Materials, are added. Biocide is preferably added to the facer and/or gypsum slurry to resist fungal growth, its effectiveness being measurable in accordance with ASTM Standard D3273.

Gypsum board in accordance with the present invention preferably is faced with a paper facer having a basis weight ranging from about 3 to 7 pounds per 100 square feet, more preferably ranging from about 4 to 5 lbs./100 sq. ft., and most preferably about 4.5 lbs./100 sq. ft. (about 220 g/m², respectively). Conventionally, wallboard is faced with kraft paper having orthotropic mechanical properties. Typical papers used for both front and back facers have basis weight of 21 g/ft². It is especially beneficial for the present facers, especially the front, to have AMD strength higher than that of conventional facers. The present facers may be formed by any suitable method.

The density of the gypsum slurry is preferably controlled by foaming. The foaming step may be carried out in any suitable way. A high-shear agitation in a rotary mixer can be used to entrain air bubbles in the slurry. Alternatively, a foaming agent or a pre-formed foam in a compatible liquid medium may be introduced during the slurry mixing. Preferably, the foaming produces a slurry with a uniform dispersion of bubbles, so that the resulting gypsum board has a porosity with voids that are uniformly distributed in size and spacing throughout the gypsum core. The foaming is done to reduce the core density, and thus the weight of the finished board. In addition, some part of the porosity of the present wallboard also results from voids left from evaporation of water droplets during the drying process. The reduced weight in turn reduces the amount of raw material required and the costs of storage and shipment, while facilitating handling and installation at a construction site.

In other process embodiments, the gypsum core is formed with a central layer and a surface layer on one or both of the central layer's surfaces. Preferably, the surface layers are formed of a primary aqueous slurry that is more dense and less porous than the central layer, which is formed using the secondary aqueous slurry. The mixer used to prepare slurry in some embodiments has a second chamber, whereby the primary aqueous slurry is formed either without foaming or with a lesser degree of foaming than the secondary aqueous slurry. Alternatively, output from the mixer may be separated into multiple streams, permitting different degrees of foaming or the addition of other constituents (e.g., reinforcing fibers) to the different slurry streams. Separate mixers may also be used for the different slurries. In either case, the primary aqueous slurry is deposited first on the lower facer to form the lower surface layer, and the secondary slurry deposited thereafter to form the central layer, whereby a multi-layer gypsum core is prepared. The primary slurry may also be applied onto the central layer to provide an upper surface layer, further stiffening the gypsum board. Incorporation of fibers in the thin surface layers is especially desirable, because even modest amounts of fiber at or near the surface (the region of highest stress in both flexure and nail pull testing) provide significant benefits, especially if the fiber is distributed substantially isotropically with respect to the MD and AMD.

It will be appreciated that there is a variation of the density and porosity of the set cementitious material in passing from the outer surface to the core of boards in certain of the multi-layer embodiments of the invention. Accordingly, it is to be understood that the cementitious core of construction boards delineated herein forms a continuous and integral matrix extending from the front to the back facers and that references made herein to different layers or sections of the board contemplate interface zones between such layers. Such interface zones may have a limited but finite thickness extent over which there may be substantial variation in composition or microstructure, e.g. in local density or porosity. For embodiments recited herein having a surface layer, it is to be understood that the thickness of the surface layer is determined by measurement from the middle of such an interface zone.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A gypsum board having a machine direction and an across machine direction, comprising:
a. a core having a front surface and a rear surface and comprising set gypsum; and
b. front and rear paper facers respectively adhered to said front and rear surfaces, said front paper facer having substantially isotropic tensile strength.

2. A gypsum board as recited by claim 1, wherein a ratio between said tensile strength of said front paper facer measured in said machine direction and in said across machine direction is at most about 3:1.

3. A gypsum board as recited by claim 2, wherein said ratio between said tensile strength of said front paper facer measured in said machine direction and in said across machine direction is at most about 2:1.

4. A gypsum board as recited by claim 2, wherein said ratio between said tensile strength of said front paper facer measured in said machine direction and in said across machine direction is at most about 1.5:1.

5. A gypsum board as recited by claim 2, wherein said ratio between said tensile strength of said front paper facer measured in said machine direction and in said across machine direction is at most about 1.2:1.

6. A gypsum board as recited by claim 1, wherein said rear paper facer has substantially isotropic tensile strength.

7. A gypsum board as recited by claim 1, wherein a ratio between said tensile strength of said rear paper facer measured in said machine direction and in said across machine direction is at most about 3:1.

8. A gypsum board as recited by claim 1, wherein at least one of said front and rear paper facers is a multi-ply paper, and at least one of said plies has a tensile strength that is higher when measured in a direction other than said machine direction than when measured in said machine direction.

9. A gypsum board as recited by claim 1, wherein said gypsum core comprises reinforcing fibers distributed substantially isotropically with respect to said machine and across machine directions of said board.

10. A gypsum board as recited by claim 9, wherein said reinforcing fibers comprise at least about 0.3 wt. % of said core.

11. A gypsum board as recited by claim 9, wherein at least a preponderance of said reinforcing fibers are selected from the group consisting of fibers of glass, mineral wool, slag wool, ceramic, carbon, metal, refractory materials, melt-blown micro-denier synthetic fibers, and mixtures thereof.

12. A gypsum board as recited by claim 1, wherein said core comprises a central layer and a front surface layer between said central layer and said front paper facer, said central and front surface layers comprising set gypsum and said front surface layer having a density higher than a density of said central layer.

13. A gypsum board as recited by claim 12, wherein said front surface layer has a thickness ranging from about 0.1 to 2 mm.

14. A gypsum board as recited by claim 12, wherein said front surface layer comprises reinforcing fibers.

15. A gypsum board as recited by claim 14, wherein at least a preponderance of said reinforcing fibers are selected from the group consisting of fibers of glass, mineral wool, slag wool, ceramic, carbon, metal, refractory materials, melt-blown micro-denier synthetic fibers, and mixtures thereof.

16. A gypsum board as recited by claim 14, wherein said reinforcing fibers are distributed with an orientation distribution that is substantially isotropic with respect to said machine direction and said across machine direction.

17. A gypsum board as recited by claim 12, wherein said core further comprises a rear surface layer between said central layer and said rear paper facer, said rear surface layer comprising set gypsum and having a density higher than said density of said central layer.

18. A gypsum board as recited by claim 17, wherein said rear surface layer has a thickness ranging from about 0.1 to 2 mm.

19. A gypsum board as recited by claim 1, further comprising a non-woven glass fiber mat disposed between said front paper facer and a center of said core.

20. A gypsum board as recited by claim 1, wherein said gypsum core further comprises at least one water repellant agent.

21. A gypsum board as recited by claim 1, wherein said core further comprises reinforcing fiber.

22. A gypsum board as recited by claim 1, wherein said gypsum core further comprises a biocide.

23. A gypsum board as recited by claim 1, said board having flame resistance sufficient to pass the test of ASTM Method E84, Class 1.

24. In a gypsum board having a set gypsum core and front and rear paper facers adhered thereto, the improvement wherein said front paper facer has substantially isotropic tensile strength.

25. A gypsum board as recited by claim 24, wherein said rear paper facer has substantially isotropic tensile strength.

26. A process for manufacturing a gypsum board having a machine direction and an across machine direction and comprising a set gypsum core having top and bottom surfaces and upper and lower paper facers respectively adhered to said top and bottom surfaces, the process comprising:
a. providing said upper and lower paper facers, at least one of said facers having substantially isotropic tensile strength;
b. preparing a primary aqueous slurry comprising at least one member selected from the group consisting of anhydrous calcium sulfate, calcium sulfate hemi-hydrate, and hydraulic setting cement;
c. forming a gypsum layer by depositing said primary aqueous slurry on said lower paper facer;
d. applying said upper paper facer onto the top of said gypsum layer to produce a board pre-form; and
e. drying said pre-form to effect curing of said gypsum layer into said set gypsum core and form said board.

27. A process as recited by claim 26, wherein said preparing of said primary aqueous slurry is carried out in a primary mixer.

28. A process as recited by claim 26, wherein said preparing of said primary aqueous slurry comprises the step of foaming said slurry.

29. A process as recited by claim 26, wherein said primary aqueous slurry further comprises reinforcing fibers.

30. A process as recited by claim 29, wherein said forming of said gypsum layer provides a distribution of said reinforcing fibers in said gypsum layer that is substantially isotropic with respect to said machine and across machine directions.

31. A process as recited by claim 26, further comprising dispersing a layer of reinforcing fibers onto said lower facer prior to said forming of said gypsum layer.

32. A process as recited by claim 26, wherein:
i. said primary aqueous slurry is divided into a first portion and a second portion, and said second portion is foamed to provide a core slurry having a density lower than a density of said first portion; and
ii. said gypsum layer comprises a lower surface layer and a central layer, said lower surface layer being formed by depositing said first portion on said lower paper facer and said central layer being formed by depositing said foamed second portion atop said lower surface layer.

33. A process as recited by claim 32, wherein reinforcing fibers are incorporated in said first portion, whereby said lower surface layer is reinforced.

34. A process as recited by claim 33, wherein said reinforcing fibers are distributed substantially isotropically with respect to said machine and across machine directions of said board.

35. A process as recited by claim 26, further comprising:
a. preparing a secondary aqueous slurry comprising at least one member selected from the group consisting of anhydrous calcium sulfate, calcium sulfate hemi-hydrate, and hydraulic setting cement; and
b. wherein said gypsum layer comprises a lower surface layer and a central layer, said lower surface layer being formed by depositing said primary aqueous slurry on said lower paper facer and said central layer being formed by depositing said secondary aqueous slurry atop said lower surface layer.

36. A process as recited by claim 35, wherein said preparing of said primary aqueous slurry is carried out in a primary mixer and said preparing of said secondary aqueous slurry is carried out in a secondary mixer.

37. A process as recited by claim 35, wherein said secondary aqueous slurry is foamed.

38. A process as recited by claim 35, wherein said gypsum layer further comprises an upper surface layer formed by depositing said primary aqueous slurry atop said central layer.

39. A cementitious construction board, comprising:
a. a layer comprising cementitious or hydraulic set material and having a first and a second face; and
b. first and second paper facers affixed to said first and second faces, at least one of said facers having a substantially isotropic tensile strength.
